(19) United States
(12) Patent Application Publication
(10) Pub. No.: US 2017/0096920 A1
(43) Pub. Date: Apr. 6, 2017

(54) EXHAUST PURIFICATION CONTROL DEVICE OF INTERNAL COMBUSTION ENGINE

(71) Applicant: DENSO CORPORATION, Kariya-city, Aichi-pref. (JP)

(72) Inventor: Hiroaki FUJII, Kariya-city (JP)

(21) Appl. No.: 15/311,665

(22) PCT Filed: Apr. 27, 2015
(86) PCT No.: PCT/JP2015/002271

§ 371 Date: Nov. 16, 2016

(30) Foreign Application Priority Data
May 22, 2014 (JP) 2014-106415

(51) Int. Cl. F01N 3/025; B01D 46/46; F01N 9/00; B01D 46/00; F01N 3/035; F01N 3/10

(52) U.S. Cl. CPC F01N 3/0253; F01N 3/035; F01N 3/101; F01N 9/002; B01D 46/0061; B01D 46/46; F01N 2510/06; B01D 2279/30; F01N 2510/065; F01N 2900/1621

(57) ABSTRACT

An engine includes a GPF disposed in an exhaust pipe, and the GPF removes, by burning, a captured PM to regenerate a capturing function. The GPF includes a catalyst layer for facilitating GPF regeneration. An ECU determines whether the catalyst layer in the GPF is deteriorated. If the catalyst layer is deteriorated, the ECU executes deterioration recovering control of raising a temperature of the GPF to a predetermined temperature or more and of making an atmosphere of the exhaust gas supplied to the GPF lean.

### CROSS REFERENCE TO RELATED APPLICATION

This application is based on Japanese Patent Application No. 2014-106415 filed on May 22, 2014, the disclosure of which is incorporated herein by reference.

### TECHNICAL FIELD

The present disclosure relates to an exhaust purification control device of internal combustion engine.

### BACKGROUND ART

As techniques of capturing and removing particulate matters (PM) contained in exhaust gas from internal combustion engines, a filter device for capturing PM in exhaust pipes has been practically implemented. Generally, such filter device is referred to as a diesel particular filter (DPF) in a case of a diesel engine and, also, is referred to as a gasoline particulate filter (GPF) in a case of a gasoline engine.

Further, in the aforementioned filter device, the captured PM is burned to be removed through a filter regeneration procedure. As techniques of facilitating the filter regeneration procedure, it is suggested that catalyst layers are formed on a carrier of the filter device (refer to Patent Literature 1). For example, it is known that silver catalyst layers are formed on the carrier of the filter device. With such silver catalyst layers, it is possible to lower the filter regeneration temperature at which the filter regeneration can be executed and, therefore, it is possible to secure the occasions of filter regeneration during running of the internal combustion engine.

It is considered that, under high temperature and low oxygen concentration states, aggregation is induced in a catalyst layer formed in a carrier in a filter device, which causes deterioration of the catalyst layer. In this case, if the catalyst layer is deteriorated, the catalyst layer is degraded in its function of lowering the filter regenerating temperature, which may reduce the effect produced by the catalyst layer.

### Prior Art Literature

### Patent Literature

### Patent Literature 1

### SUMMARY OF INVENTION

It is an object of the present disclosure to provide an exhaust purification control device of internal combustion engine, which is capable of normalizing the function of a catalyst layer in a filter device for capturing PM.

According to an aspect of the present disclosure, an exhaust purification control device is applied to an internal combustion engine that includes a filter device disposed in an exhaust pipe and adapted to capture a PM in exhaust gas. The captured PM is burned to be removed for regenerating a capturing function of the filter device. The filter device includes a catalyst layer disposed on a surface of a carrier to facilitate filter regeneration. Particularly, the exhaust purification control device includes a deterioration determination portion which determines whether the catalyst layer is deteriorated, and a recovery control portion which executes a deterioration recovering control for raising a temperature of the filter device to a temperature higher than or equal to a predetermined temperature. The recovery control portion makes the exhaust gas supplied to the filter device lean, when the deterioration determination portion determines that the catalyst layer is deteriorated.

With the filter device having the catalyst layer disposed on the surface of the carrier to facilitate filter regeneration, it is possible to lower the filter regeneration temperature for facilitating the filter regeneration. However, if the catalyst layer is deteriorated due to aggregation, the catalyst layer is degraded in its function of lowering the filter regeneration temperature. If it is determined that the catalyst layer is deteriorated, the deterioration recovering control is executed to raise the temperature of the filter device to a temperature higher than or equal to the predetermined temperature and make the exhaust gas supplied to the filter device lean. This causes re-diffusion in the catalyst layer of the filter device, thereby attaining recovery of the function of the catalyst layer. This can normalize the function of the catalyst layer in the filter device for capturing PM.

### BRIEF DESCRIPTION OF DRAWINGS

FIG. 1 is a structural view illustrating a general outline of an engine control system according to an embodiment.

FIG. 2 is a view illustrating a relationship between a PM capturing rate and a time.

FIG. 3 is a flowchart illustrating a procedure of a deterioration recovering control for a GPF catalyst layer.

FIG. 4 is a time chart illustrating, in more detail, determination of deterioration of the catalyst layer.

FIG. 5 is a time chart illustrating, in more detail, deterioration recovering control for the catalyst layer.

FIG. 6 is a flowchart illustrating a procedure of a deterioration recovering control for a GPF catalyst layer, according to another embodiment.

### EMBODIMENTS FOR CARRYING OUT INVENTION

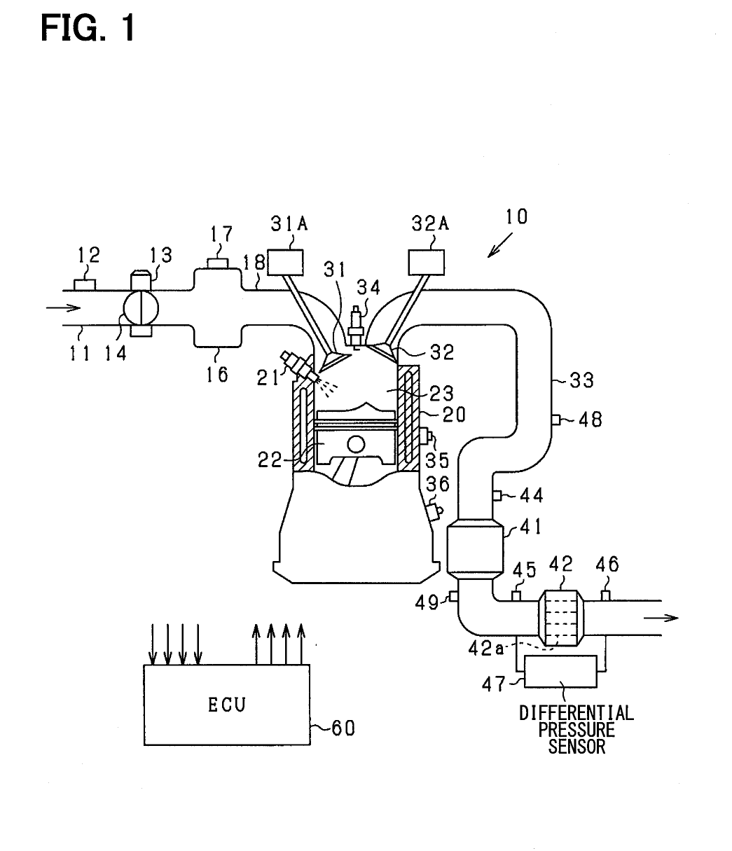

Hereinafter, an embodiment of the present disclosure will be described with reference to the drawings. In the present embodiment, a multi-cylinder four-cycle gasoline engine of an in-cylinder injection type which is incorporated in a vehicle is subjected to control, and various actuators in this engine are electronically controlled. An entire general structure of an engine control system will be described with reference to FIG. 1.

In an engine 10 illustrated in FIG. 1, an intake pipe 11 is provided with an air flow meter 12 for detecting the amount of intake air. A throttle valve 14 is disposed downstream of the air flow meter 12 and is adjusted in terms of the degree of opening by a throttle actuator 13 such as a DC motor. The degree of opening (the throttle position) of the throttle valve 14 is detected by a throttle position sensor incorporated in the throttle actuator 13. A surge tank 16 is disposed downstream of the throttle valve 14, and an intake pressure sensor 17 for detecting the pressure in the intake pipe is mounted to the surge tank 16. An intake manifold 18 for introducing air into respective cylinders in the engine 10 is coupled to the surge tank 16.

An engine main body 20 is provided with an electromagnetically driven injector 21 for each cylinder, and the injector 21 directly injects a fuel into a combustion chamber 23 which is defined and formed by the inner wall of the cylinder and the upper surface (the top portion) of a piston 22. The injector 21 is supplied with the high-pressure fuel from a high-pressure fuel system including a high-pressure pump. In the high-pressure fuel system, the fuel in a fuel tank is pumped up by a low-pressure pump, and the pressure of the fuel is raised by the high-pressure pump. Further, the high-pressure fuel accumulated in a pressure accumulation chamber (a delivery pipe) is injected through the injector 21 into each cylinder.

The engine 10 has an intake port and an exhaust port which are provided with an intake valve 31 and an exhaust valve 32, respectively, which perform opening and closing operations according to the rotations of respective cam shafts (not illustrated). Through the opening operation of the intake valve 31, intake air is introduced into the combustion chamber 23. Through the opening operation of the exhaust valve 32, the exhaust gas resulted from combustion is discharged to an exhaust pipe 33. The intake valve 31 and the exhaust valve 32 are respectively provided with a variable valve mechanism 31A and a variable valve mechanism 32A which vary opening and closing timings of the respective valves. The variable valve mechanisms 31A and 32A adjust the rotational phases of the respective cam shafts for air intake and exhaust with respect to the crank shaft of the engine 10, which enables phase adjustments in the advance direction and in the retard direction with respect to a predetermined reference position. As the variable valve mechanisms 31A and 32A, it is possible to employ variable valve mechanisms of a hydraulic-driving type or an electric-driving type.

In the engine 10, an ignition plug 34 is mounted to a cylinder head of each cylinder. A high voltage is applied to the ignition plug 34 at desired ignition timing, through an ignition coil or the like, which is not illustrated. The application of the high voltage induces spark discharge between counter electrodes in each ignition plug 34, so that the fuel in the combustion chamber 23 is ignited to be combusted.

Further, the engine main body 20 is provided with a water-temperature sensor 35 for detecting an engine water temperature (which corresponds to an engine temperature), and a crank-angle sensor 36 for outputting a rectangular crank-angle signal at intervals of a predetermined crank angle (at a period of 10° CA, for example), during running of the engine 10.

The exhaust pipe 33 is provided with a three-way catalyst 41 and a gasoline particulate filter (GPF) 42, as an exhaust purification device for purifying the exhaust gas. The three-way catalyst 41 purifies CO, HC and NOx in the exhaust gas. The GPF 42 is disposed downstream of the three-way catalyst 41 to capture PM in the exhaust gas. The GPF 42 is a filter device including a carrier (a filter base member) made of a porous ceramic, for example and capturing PM through this carrier. As is well known, the carrier in the GPF 42 has a wall-flow configuration including a plurality of cells defined by partition walls, and closure portions for alternately closing the end portions of the cells adjacent to each other. Further, in the present embodiment, the GPF 42 includes a catalyst layer 42a for facilitating a GPF regeneration, by carrying a silver catalyst on the surface of the carrier.

The PM captured by the GPF 42 are repeatedly removed by being burned during running of the engine 10, thereby executing the regeneration of the PM capturing function (regeneration of the GPF). This regeneration of the GPF is executed under a condition where the GPF 42 is at a predetermined high-temperature state and, also, oxygen exists in the GPF 42. For example, the regeneration of the GPF is executed during fuel cut of the engine 10. Further, as is conventionally well known, by providing the catalyst layer 42a made of a silver catalyst in the GPF 42, it is possible to lower the temperature at which the GPF 42 is regenerated (PM burning temperature). By employing the GPF provided with the silver catalyst, it is possible to properly secure occasions of regeneration of the GPF.

In the exhaust pipe 33, air-fuel ratio sensors 44 and 45 are respectively disposed upstream and downstream of the three-way catalyst 41 to detect the air-fuel ratio of an air-fuel mixture in the exhaust gas. Further, a PM sensor 46 is disposed downstream of the GPF 42 to detect the amount of PM (PM concentration) which have passed through the GPF 42 and have been discharged downstream thereof. For example, the PM sensor 46 includes a light emitting element and a light receiving element which are opposed to each other in such a manner that the exhaust gas passes between these elements. In this case, as the amount of PM (PM concentration) in the exhaust gas becomes larger, the amount of light which reaches the light receiving element from the light emitting device is more decreased. Thus, the amount of PM in the exhaust gas can be detected based on the amount of light received by the light receiving element. Further, the GPF 42 is provided with a differential pressure sensor 47 for detecting the difference in pressure (the differential pressure) between an upstream side and a downstream side thereof.

The exhaust pipe 33 is provided with a fuel adding valve 48 disposed upstream of the three-way catalyst 41 to add the fuel into the exhaust pipe 33. Further, the exhaust pipe 33 is provided with an air supply portion 49 disposed between the three-way catalyst 41 and the GPF 42 to supply air into upstream of the GPF 42.

Outputs from the aforementioned various sensors are inputted to an electronic control unit (ECU) 60 which performs engine control. The ECU 60 includes a microcomputer which has a CPU, a ROM, a RAM, and the like. The ECU 60 executes various control programs stored in the ROM to control the amount of fuel injection from the injector 21 and to control the timing of ignition of the ignition plug 34, according to the engine running state. For example, regarding the control of the amount of fuel injection, the ECU 60 executes feedback control of the air-fuel ratio, based on the results of the detections by the air-fuel ratio sensors 44 and 45. Further, the ECU 60 executes fuel cut for temporarily stopping the fuel injection for the engine 10, when a fuel-cut condition is satisfied, for example, the accelerator is off or the engine speed is more than or equal to a predetermined value.

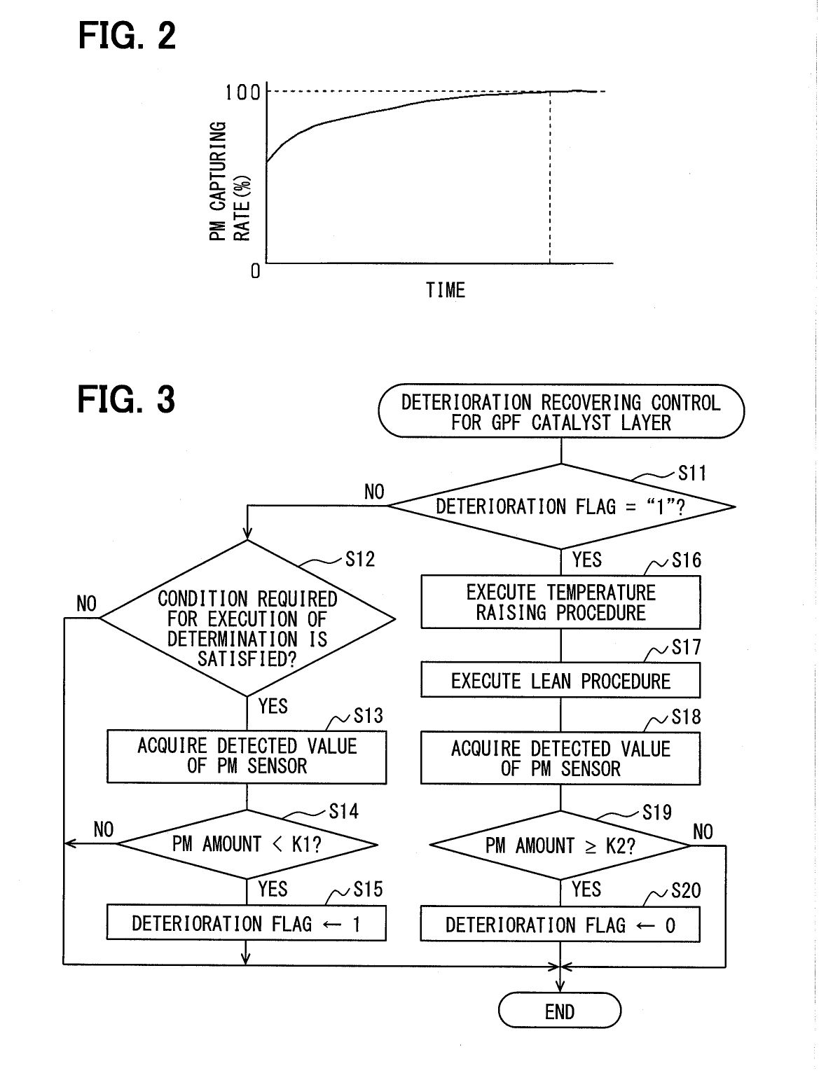

In the GPF 42, the PM capturing rate (%) varies depending on the time, according to the PM deposition state in the GPF 42. During running of the engine 10, the PM capturing rate varies with the elapse of time, as illustrated in FIG. 2, for example. The PM capturing rate corresponds to the ratio of the amount of captured PM to a predetermined amount of PM in the exhaust gas. Specifically, referring to FIG. 2, in an initial state where no PM has been captured in the GPF 42 (a state where the amount of deposited PM is zero or slight), the PM capturing rate is relatively small. Thereafter, along with the elapse of time, as the amount of PM deposited in the GPF 42 gradually increases, the PM capturing rate gradually increases. This is because the passage of PM through the GPF 42 is varied depending on the amount of PM deposited in the GPF 42. It is considered that, in the initial state where there is a smaller amount of deposited PM, the PM are more prone to pass through the GPF 42, which causes reduction of the PM capturing rate.

Hereinafter, a supplemental description will be given of the relationship between the process of PM deposition and the PM capturing rate. At first, when the GPF 42 is in an initial state (a state where the GPF 42 captures no PM), there is no PM adhered to the wall surfaces of the pores formed in the GPF carrier. Therefore, the PM having reached the GPF 42 are prone to pass through the GPF 42, so that PM flow downstream of the GPF without being captured by the GPF 42. This makes the PM capturing rate smaller. Thereafter, as the PM gradually adhere to the pore wall surfaces in the GPF 42, the PM having adhered to the pore wall surfaces allow following PM to easily adhere to the pore wall surfaces. This gradually increases the PM capturing rate.

Thereafter, the PM are deposited in the pores to form bridges at the pore entrances, which causes the PM capturing rate to reach about 100%. Further, thereafter, the PM are deposited on the surface portion of the carrier and, in this state, the PM capturing rate is maintained at about 100%.

The catalyst layer 42a in the GPF 42 has the function of facilitating the GPF regeneration. If the catalyst layer 42a is deteriorated due to aggregation of Ag, the catalyst layer 42a is deteriorated in its function of lowering the GPF regeneration temperature. It is considered that the catalyst layer 42a is gradually deteriorated under high temperature and low oxygen concentration conditions, for example. Therefore, in the present embodiment, if it is determined that the catalyst layer 42a has been deteriorated, a deterioration recovering control is executed. The degradation recovering control involves raising the temperature of the GPF 42 to a predetermined temperature or more (a temperature higher than the temperature thereof during normal running), and making the exhaust gas supplied to the GPF 42 lean. This causes re-diffusion of Ag aggregated in the catalyst layer 42a in the GPF 42, thereby attaining recovery of the function of the catalyst layer 42a.

More specifically, in executing regeneration of the GPF along with execution of fuel cut, the ECU 60 determines the presence or absence of deterioration of the catalyst layer 42a based on the amount of PM (the PM concentration) downstream of the GPF 42. Further, if it is determined that there has occurred deterioration of the catalyst layer 42a, the ECU 60 executes the deterioration recovering control.

FIG. 3 is a flowchart illustrating the procedure of the deterioration recovering control for recovering deterioration of the GPF catalyst layer. This procedure is repeatedly executed at a predetermined time cycle by the ECU 60.

Referring to FIG. 3, in step S11, it is determined whether a deterioration flag is being set to “1” at the present time. The deterioration flag is a flag as follows. That is, if it is determined that the catalyst layer 42a in the GPF 42 is in a deteriorated state, that is, if it is determined that the function of lowering the GPF regeneration temperature has been deteriorated due to aggregation of Ag, the deterioration flag is set to “1”. Initially, the deterioration flag equals to zero, and step S11 results in negative.

When step S11 results in negative, the procedure proceeds to step S12 where it is determined whether there is satisfied a condition required for executing determination of deterioration of the catalyst layer 42a. In step S12, it is determined that the condition required for execution of the determination is satisfied, if fuel cut is executed immediately before step S12, and a condition required for executing the GPF regeneration is satisfied along with the fuel cut. Further, if the condition required for execution of the determination is satisfied, the procedure proceeds to step S13. Also, the condition required for executing deterioration determination may be that fuel cut is being executed.

In step S13, the value detected by the PM sensor 46 is acquired. In step S14, the presence or absence of deterioration of the catalyst layer 42a in the GPF 42 is determined, based on a comparison between a predetermined determination value K1 and the amount of PM downstream of the GPF, which is calculated from the value detected by the PM sensor 46. At this time, it is determined whether the amount of PM is less than K1.Step S14 is procedure of determining whether the GPF regeneration is not properly executed, due to deterioration of the catalyst layer 42a.

In this case, if the catalyst layer 42a normally functions, the GPF regeneration is normally executed during fuel cut, for example. Accordingly, along with the execution of the GPF regeneration, the PM capturing rate in the GPF 42 is reduced, which increases the amount of PM (the PM concentration) downstream of the GPF. Thus, it is determined that the catalyst layer 42a is normal. On the contrary, if the catalyst layer 42a has been deteriorated, the GPF regeneration is not normally executed during fuel cut, for example. Accordingly, the PM capturing rate in the GPF 42 is not largely decreased and, therefore, the amount of PM (the PM concentration) downstream of the GPF is not largely increased. Thus, it is determined that the catalyst layer 42a is deteriorated.

If it is determined that the catalyst layer 42a is deteriorated, the present procedure proceeds to step S15 where the deterioration flag is set to “1”.

Further, in the state where the deterioration flag has been set to “1”, step S11 results in positive, and the procedure proceeds to step S16. Further, in step S16, temperature raising procedure of raising the temperature in the exhaust pipe 33 is executed. In step S17, a lean procedure of making the gas (the exhaust gas) flowing into the GPF 42 lean is executed. The temperature raising procedure and the lean procedure correspond to the deterioration recovering control.

At this time, in the temperature raising procedure, the temperature in the exhaust pipe at the present time is determined through detection or estimation and, further, it is determined whether the temperature in the exhaust pipe is lower than or equal to a predetermined temperature (e.g., 700° C.). Further, if the temperature in the exhaust pipe is lower than or equal to the predetermined temperature, the temperature in the exhaust pipe is raised through control of the engine running and the like. For example, by supplying an unburned fuel to the exhaust pipe 33, a combustion reaction of the unburned fuel is generated in the exhaust pipe 33, thereby raising the temperature in the exhaust pipe. More specifically, at least one procedure is executed, out of procedure of retarding ignition timing and procedure of supplying the fuel into the exhaust pipe 33 upstream of the GPF 42. The supply of the fuel into the exhaust pipe 33 can be executed using the fuel adding valve 48 provided in the exhaust pipe 33.

Further, as the lean procedure, at least one procedure is executed, out of procedure of making the combusted air-fuel mixture in the engine 10 lean and procedure of supplying air (fresh air) into the exhaust pipe 33 upstream of the GPF 42. The supply of air upstream of the GPF 42 can be executed, using the air supply portion 49 provided between the three-way catalyst 41 and the GPF 42 in the exhaust pipe 33.

As the temperature raising procedure, it is also possible to execute procedure of making the combusted fuel-air mixture in the engine 10 rich. As the lean procedure, it is also possible to supply air through the air supply portion 49.

Thereafter, in step S18, the value detected by the PM sensor 46 is acquired. In step S19, it is determined whether the deterioration recovery for the catalyst layer 42a has been completed, based on a comparison between a predetermined determination value K2 and the amount of PM downstream of the GPF, which is calculated from the value detected by the PM sensor 46. At this time, it is determined whether the amount of PM is larger than or equal to K2. The determination value K2 is a value larger than the determination value K1. If step S19 results in negative, the present procedure ends at this time. If step S19 results in positive, the present procedure proceeds to step S20. If the present procedure proceeds to step S20, the deterioration flag is reset to 0 and, thereafter, the present procedure ends.

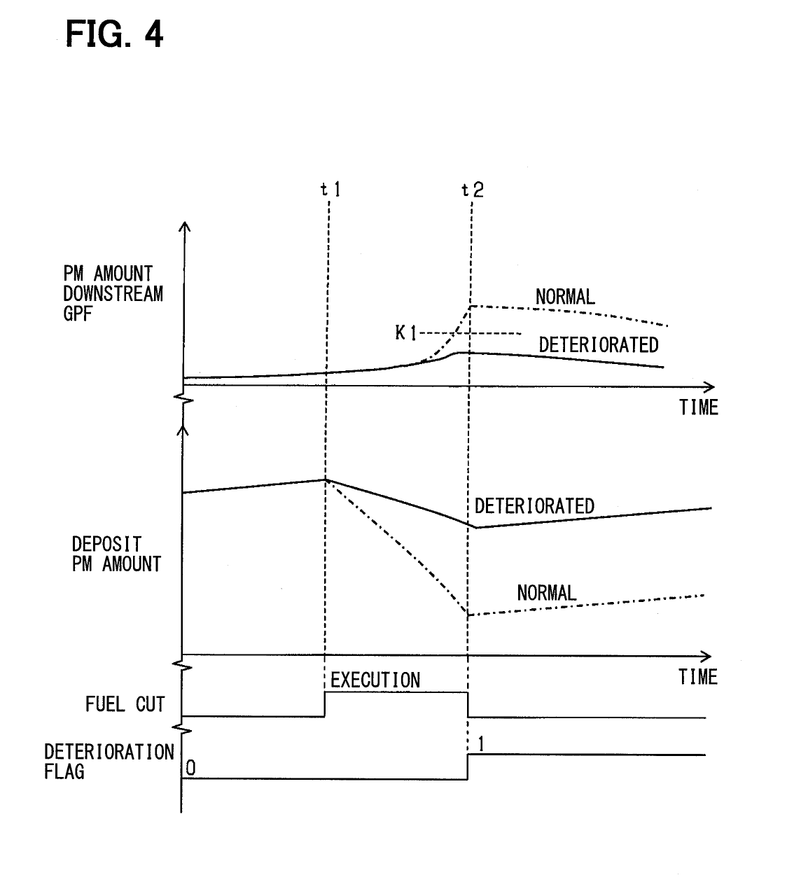

FIG. 4 is a time chart illustrating, in detail, the determination of deterioration of the catalyst layer 42a through the aforementioned deterioration recovering control. Further, in charts of the amount of PM (the amount of PM downstream of the GPF) and the amount of deposited PM, dashed lines from t1 indicate their behaviors of when the catalyst layer 42a is normal, while solid lines indicate their behaviors of when the catalyst layer 42a is deteriorated.

Referring to FIG. 4, before the timing t1, the amount of deposited PM in the GPF 42 is relatively large. At the timing t1, fuel cut is executed and, further, the GPF regeneration is executed. This decreases the amount of deposited PM. However, in comparison between the case where the catalyst layer 42a is normal and the case where the catalyst layer 42a is deteriorated, there is a difference therebetween in degree of decrease of the amount of deposited PM. In the case where the catalyst layer 42a is deteriorated, the amount of deposited PM is decreased to a smaller degree. In this case, although the GPF regeneration is executed, if the amount of deposited PM is decreased to a smaller degree, the PM capturing rate of the GPF 42 is not largely reduced. Therefore, in the case where the catalyst layer 42a is deteriorated, the amount of PM downstream of the GPF is not largely increased. This enables determining deterioration of the catalyst layer 42a, based on the amount of PM downstream of the GPF.

Further, at timing t2 when the fuel cut has been completed, if the amount of PM downstream of the GPF is smaller than K1, the deterioration flag is set to 1.

Further, besides the deterioration determination based on the comparison between the determination value K1 and the amount of PM downstream of the GPF, with the determination value K1 preliminarily determined as illustrated in the figure, it is also possible to execute deterioration determination, based on the amount of change in amount of PM before and after the GPF regeneration (before and after the fuel cut). Also, it is possible to calculate the amount of deposited PM based on the value detected by the differential pressure sensor 47 (the differential pressure between portions before and after the GPF 42), and to execute deterioration determination based on the amount of change in amount of deposited PM before and after the GPF regeneration (before and after the fuel cut).

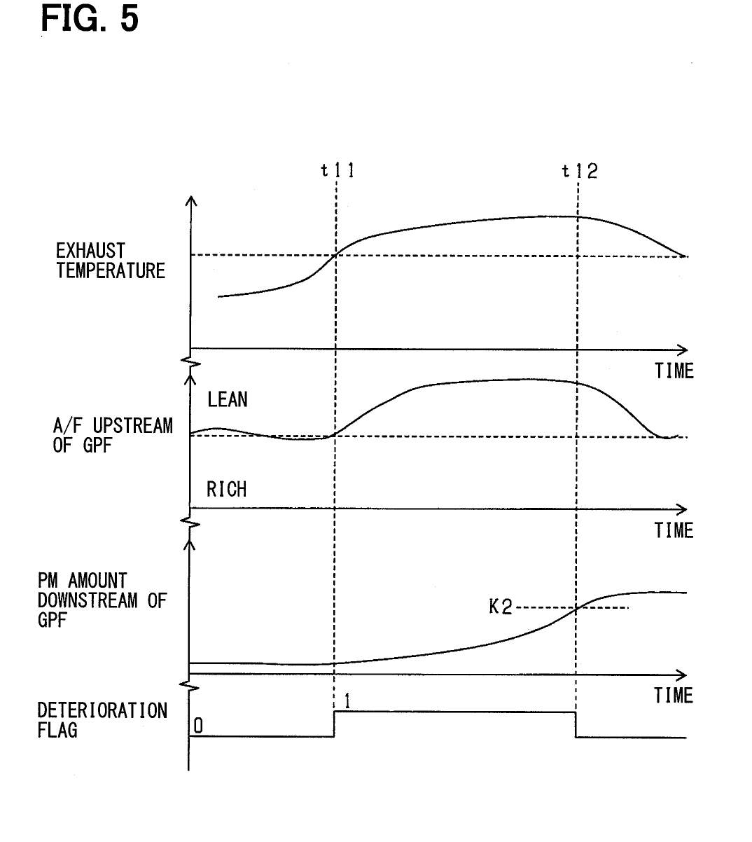

FIG. 5 is a time chart illustrating, in more detail, the deterioration recovering control for the catalyst layer 42a.

Referring to FIG. 5, at timing t11, since the deterioration flag is set, the temperature raising procedure and the lean procedure are started as the deterioration recovering control. Thus, the temperature in the exhaust pipe is raised and, also, the atmosphere upstream of the GPF is made lean. After the timing t11, re-diffusion of Ag in the catalyst layer 42a is induced, which gradually recovers the function of the catalyst layer 42a.

The start of the deterioration recovering control is required only to be after the timing when the deterioration flag is set to 1. This deterioration recovering control can be also started after it is determined whether the deterioration recovering control (the temperature raising procedure and the lean procedure) can be executed after the deterioration flag has been set. For example, by defining a condition required for permission as that the vehicle is not being accelerated, and the like, the deterioration recovering control can be executed if this condition is satisfied.

The amount of PM downstream the GPF gradually increases along with the execution of the deterioration recovering control. At timing t12, the amount of PM reaches the determination value K2. Thus, the deterioration flag is reset, and the deterioration recovering control is completed.

With the present embodiment described in detail above, it is possible to provide excellent effects as follows.

With the GPF 42 provided with the catalyst layer 42a for facilitating the GPF regeneration, it is possible to lower the GPF regeneration temperature for facilitating the GPF regeneration. However, if the catalyst layer 42a is deteriorated due to aggregation, its function of lowering the GPF generating temperature is deteriorated. The aforementioned structure is adapted to execute deterioration recovering control of raising the temperature of the GPF 42 to a predetermined temperature or more and of making the atmosphere of the exhaust gas supplied to the GPF 42 lean, if it is determined that the catalyst layer 42a has been deteriorated. This can cause re-diffusion in the catalyst layer 42a, thereby recovering the function of the catalyst layer 42a. This can normalize the function of the catalyst layer 42a in the GPF 42.

The determination of deterioration of the GPF 42 (the catalyst layer 42a) is executed in association with execution of fuel cut, utilizing the fact that, if the GPF regeneration is properly executed to reduce the amount of PM deposited in the GPF 42, the PM capturing rate is reduced and the amount of PM downstream of the GPF is increased. This enables securing high accuracy of the deterioration determination and properly executing the deterioration recovering control.

In executing the GPF regeneration based on execution of fuel cut, the deterioration recovering control is executed on the condition that the amount of PM (the PM concentration) downstream the GPF 42 is less than the determination value K1. Thereafter, the deterioration recovering control is completed on the condition that the amount of PM (the PM concentration) has reached the determination value K2 (>K1). This enables properly executing the deterioration recovering control, while monitoring the change of the actual amount of deposited PM.

As the temperature raising procedure for recovering deterioration, procedure of combusting an unburned fuel in the exhaust pipe 33 is executed. As the procedure of making the exhaust gas lean, procedure of introducing a lean gas into the GPF 42 is executed. This enables an immediate transition of the catalyst layer 42a having been in a deteriorated state to a state of having been recovered in function. For example, with a structure adapted to supply an unburned fuel into the exhaust pipe 33 through the fuel adding valve 48 and to supply air to a portion upstream the GPF through the air supply portion 49, it is possible to properly execute the deterioration recovering control, while inhibiting it from exerting influences on the output of the engine 10.

### Other Embodiments

The aforementioned embodiment can be also changed as follows, for example.

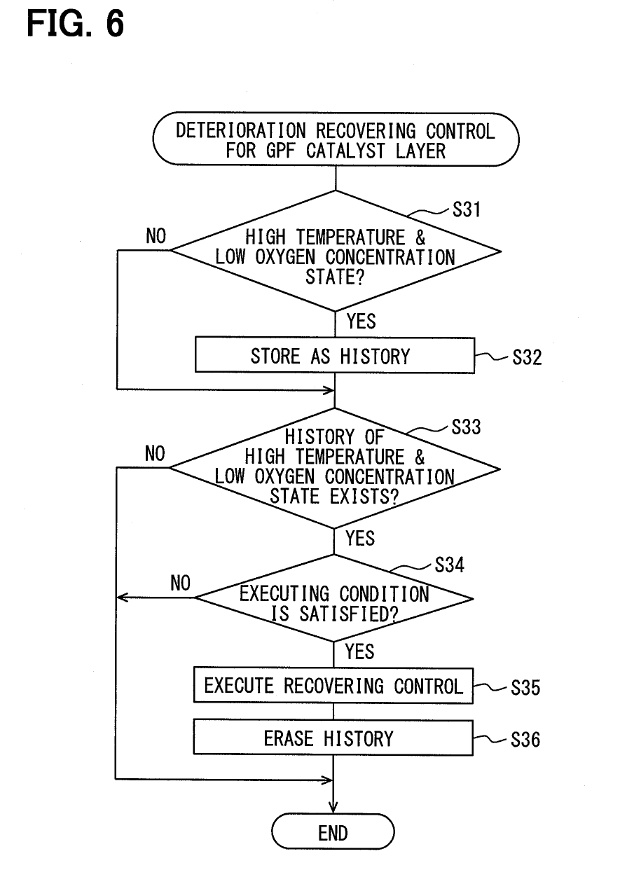

It is considered that the catalyst layer 42a in the GPF 42 is gradually deteriorated under high temperature and low oxygen concentration conditions. Therefore, a history of exhaust gas from the engine 10 in a predetermined high temperature and low oxygen concentration state can be successively stored in a memory (a backup area) in the ECU 60. Further, based on this history, deterioration recovering control can be executed. More specifically, procedure in FIG. 6 can be executed. The procedure in FIG. 6 can be repeatedly executed at a predetermined time cycle by the ECU 60.

Referring to FIG. 6, in step S31, it is determined whether the GPF 42 is being in a predetermined high temperature and low oxygen concentration state at the present time. If this results in YES, this state is stored as a history in the memory, in step S32. The determination as to whether the GPF 42 is being in the predetermined high temperature and low oxygen concentration state can be executed from values detected by sensors and the like or from estimated values based on the engine running state.

Thereafter, in step S33, it is determined whether there exists a history of the fact that the GPF 42 has been in the predetermined high temperature and low oxygen concentration state. In step S34, it is determined whether there is satisfied a condition required for executing deterioration recovering control at the present time. This condition required for execution of the deterioration recovering control preferably includes that the vehicle is not being accelerated, and the like, for example. Further, if both steps S33 and S34 result in YES, the present procedure proceeds to step S35. In step S35, temperature raising procedure of raising the temperature in the exhaust pipe 33 and lean procedure of making the gas (the exhaust gas) flowing into the GPF 42 lean are executed, as the deterioration recovering control (similarly to steps S16 and S17 in FIG. 3). Thereafter, in step S36, the information about the history of the past high temperature and low oxygen concentration states stored in the memory is erased.

With the aforementioned structure, it is possible to grasp the fact that the catalyst layer 42a has been deteriorated, based on the existence of a history of exhaust gas in the high temperature and low oxygen concentration states. Therefore, it is possible to properly execute the deterioration recovering control, according to the presence or absence of deterioration in the catalyst layer 42a.

The catalyst layer 42a for facilitating the GPF regeneration can be also a catalyst layer containing an oxide of silver, as well as a catalyst layer containing silver. In other words, the catalyst layer 42a may be any catalyst layer having a function of facilitating the GPF regeneration.

The present disclosure can be also applied to a system including a diesel particulate filter (DPF).

1. An exhaust purification control device to be applied to an internal combustion engine that includes a filter device disposed in an exhaust pipe and adapted to capture a PM in exhaust gas and removes, by burning, the PM captured by the filter device to regenerate a capturing function, the filter device including a catalyst layer disposed on a surface of a carrier to facilitate filter regeneration, the exhaust purification control device comprising:
a deterioration determination portion adapted to determine whether the catalyst layer is deteriorated; and
a recovery control portion adapted to execute deterioration recovering control of raising a temperature of the filter device to a predetermined temperature or more and making an atmosphere of the exhaust gas supplied to the filter device lean, when the deterioration determination portion determines that the catalyst layer is deteriorated.

2. The exhaust purification control device according to claim 1, wherein
the deterioration determination portion determines presence or absence of deterioration of the catalyst layer, based on an amount of PM in the exhaust gas having passed through the filter device, under a condition where filter regeneration in the filter device is executed or a condition immediately after the execution of the filter regeneration.

3. The exhaust purification control device according to claim 2, wherein:
the deterioration determination portion determines that the catalyst layer is deteriorated, when the amount of PM in the exhaust gas having passed through the filter device is less than a first determination value, under the condition where filter regeneration in the filter device is executed or the condition immediately after the execution of the filter regeneration; and
the recovery control portion completes the deterioration recovering control, based on the fact that the amount of PM in the exhaust gas having passed through the filter device reaches a second determination value which is larger than the first determination value, under the condition where the deterioration recovering control is executed.

4. The exhaust purification control device according to claim 1, further comprising:
a storage portion adapted to store a history of the exhaust gas in the internal combustion engine in a predetermined high temperature and low oxygen concentration state,
wherein
the recovery control portion executes the deterioration recovering control, based on the history stored in the storage portion.

5. The exhaust purification control device according to claim 1, wherein:
the recovery control portion executes procedure of combusting an unburned fuel in the exhaust pipe, as procedure of raising the temperature of the filter device; and
the recovery control portion executes procedure of introducing a lean gas into the filter device, as procedure of making the exhaust gas supplied to the filter device lean.
